(19) United States
(12) Patent Application Publication
(10) Pub. No.: US 2020/0078830 A1
(43) Pub. Date: Mar. 12, 2020

(54) MULTI-TOOL DEVICE FOR CLEANING AND MAINTENANCE OF ELECTRONIC DEVICES

(71) Applicant: Josh Swinnerton, Manchester-by-the-Sea, MA (US)

(72) Inventor: Josh Swinnerton, Manchester-by-the-Sea, MA (US)

(21) Appl. No.: 16/563,456

(22) Filed: Sep. 6, 2019

Related U.S. Application Data
(60) Provisional application No. 62/728,790, filed on Sep. 8, 2018.

(51) Int. Cl. B08B 1/00; B08B 7/04

(52) U.S. Cl. CPC B08B 1/001; H04B 1/3827; B08B 7/04

(57) ABSTRACT

A cleaning and maintenance multi-tool for electronic devices is provided, which includes multiple tools in a single body, where the tools are capable of cleaning different components of mobile electronic devices such as smart phones, tablets, digital cameras, laptop or PC computers, or the like.

### BACKGROUND

Popular mobile electronic devices, especially mobile phones and tablets, are an increasingly important part of daily life, often being carried or stored by users at all times and through all types of environments. Such use frequently exposes devices to a range of debris and contaminants, especially dust, lint, hair, tissue, skin oil, being handled often and stored informally in pockets, purses, bags, vehicles and other unclean environments.

Such contaminants over time may collect in any opening in the surface of electronic devices, especially the electronic connection ports, switches, buttons, speakers and microphones. If not cleaned regularly, such contamination can hamper the correct functioning of these components and is likely to cause unreliable electrical connections on the device where the contaminant blocks or adds resistance to a clean electrical contact.

Such contamination can also cause electrical arcing across the connecting pins which leads to oxide damage or scorching which further impedes a reliable electrical connection.

### BRIEF SUMMARY

In an embodiment, a device suitable for cleaning an electrical device is provided. The device may include a plurality of tools, each tool comprising a handle portion and a cleaning portion, each cleaning portion being different from the cleaning portion of each other tool; and a main tool body comprising a plurality of tool connection points. The handle portion of each tool may be removably connected to the main tool body via at least one of the tool connection points. Each tool may be connectable to the main tool body such that the cleaning portion is disposed within the main tool body, and each tool of the plurality of tools is also connectable to the main tool body such that the cleaning portion is disposed outside the main tool body.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an approximate scale of an example embodiment of a multi-tool with a hub-and-spoke layout in a seven tool-tip embodiment of a multi-tool as disclosed herein, including an equal radial placement of each tool.

FIG. 2A shows an example of a multi-tool as disclosed herein in its closed state.

FIG. 2B shows an example of a multi-tool as disclosed herein with the individual male tools being removed.

FIG. 2C shows an example of a multi-tool as disclosed herein with the individual male tools being rotated for mounting in the main body and mounted in the open state thereby allowing the use of the main body as a handle.

FIG. 2D shows an example of a multi-tool as disclosed herein with individual male tools rotated and removed from the main body.

FIG. 3 shows a cut-away perspective view of an example of a multi-tool as disclosed herein, showing how individual tool-tips may be positioned when in closed and open states, with female tools positioned on one side of the radial array of tool-tips.

FIGS. 4A-4F show examples of individual tools of an embodiment of a multi-tool as disclosed herein; FIG. 4A shows an example of a device brush; FIG. 4B shows an example of a male port pick; FIG. 4C shows an example of a male port abrasive; FIG. 4D shows an example of a male port brush; FIG. 4E shows an example of a male port nib; FIG. 4F shows an example of a female connector nib disposed within the main body and shows an example of a female connector abrasive disposed within the main body.

FIG. 5A shows a cross-section view of a multi-tool with an example tool engaged in a “stored” arrangement as disclosed herein.

FIG. 5B shows a cross-section of the multi-tool shown in FIG. 5A, with the example tool arranged for use and inserted into the tool body as disclosed herein.

FIG. 6 shows an example of a female tool that includes a compliant material arranged around the opening that deforms to apply a compressive force onto the plug as disclosed herein.

FIG. 7 shows examples of layouts for a male twisted wire brush designed to allow cleaning of female electronic ports, including USB-C/Mini/Micro, Apple Lightning, HDMI, and other ports, according to embodiments disclosed herein.

FIG. 8A shows an example of a single male tool as disclosed herein being used mounted in the open state, with the main tool body being used as a handle.

FIG. 8B shows a single male tool as disclosed herein being used independently of the main body in an alternative mode which is also supported.

FIG. 9 shows an example of a female tool being used to clean a male connector on a smart phone charging cable, by inserting the connector into the female tool, according to an embodiment of a multitool as disclosed herein.

FIG. 10 shows an embodiment of a multitool main body as disclosed herein, in which tools may be stored linearly along the handle of the main body and a single tool is inserted into the end of the main body for use.

FIG. 11 shows an embodiment of a multi-tool device as disclosed herein, in which tools may be cylindrically arranged around the handle of the main body and a single tool may be inserted into the end of the main body for use.

### DETAILED DESCRIPTION

Due to the collection of contaminants, oxidation, and other issues with electrical connections common to modern portable electronic devices, it has been determined that there is a need for a cleaning and maintenance tool that can address all the above concerns, allowing easy cleaning of the various common different types of contaminants to these critical components of electronic devices and also repair oxide damage where it has already occurred. Specifically, it has been found that a suitable and desirable tool combines multiple tool tips to best clean the various types of contaminants, thereby allowing for cleaning of both the device and its associated cables and accessories, and repair of oxide damage to the electrical contacts where it has occurred.

Embodiments disclosed herein provide a single multi-tool that may include multiple individual tools, each of which may be designed to clean the various types of debris commonly known to impact electronic devices, which may be incorporated into a single main tool body. The individual tools may allow for cleaning both the device's electrical connections, its cables and accessories, its switches, buttons, microphones, speakers, other sensors and openings.

One purpose of a multi-tool device as disclosed herein is to clean and restore functionality to an 8-pin or similar electrical connector, such as Apple's Lightning™ connectors found on their devices and accessories. The female port receptacle resides on the device and the male connector plug is normally attached to a USB cable, both used for charging and transferring data. This physical connection system still remains a fundamental technology even in the advent of wireless data and charging. A device's female connection port will suffer from lint, dust, hair, moisture and dirt ingress during everyday usage. A male connection plug will often amass scorch marks, corrosion patches, dirt and finger oils over its electrical contact pins.

The accumulation of this unwanted material in the female port and on the male plug prevents the connectors from docking and transferring power and data successfully. In some cases, there is so much debris inside, it prevents the plug from clipping into the port's retention mechanism. Depending on the quantity of contaminants and state of the connectors, when charging and synching their devices, users experience annoying connectivity errors and slow charging from a reduction in power and interference in signal.

In addition to the connector port, other regions of the device can collect dust, debris and impurities. These include speaker holes, headphone jacks, mechanical buttons and switches. Everyone owning a smart device can attest to touch screens becoming dirty with finger prints, skin oils and moisture. Being able to clean the display and other regions of the device is a valuable function and could present the product as a complete kit for cleaning Apple's flagship devices, such as iPhone and iPad.

In embodiment as shown and described herein, male plug tools are detachable and snap into the main body of the product. In a first mode of use each male tool can be removed by the user, held between their index finger and thumb, then used to clean the port. These finger tools afford fine motor movements when inside the extremely small port. For example, the nominal size of a Lightning port is 1.6×6.7×7.0 mm. In some embodiments, each tool of the mulit-tool as disclosed herein may be sized appropriately to clean the Lighting port and plug. Alternatively or in addition, tools may be sized based on particular ports such as USB, mini- or micro-USB, USB-C, or any other suitable port size. In some embodiments, tools may have dimensions suitable for use with multiple types of plugs and ports. Some of the male tools may be tapered or otherwise sized or shaped to allow line of sight into the port to give the user feedback (so the user can see the angle/position of the tool in the port) and allow the user to see when they have displaced and removed the debris. Various dimensions may be used for the male tools, for example, 25-30 mm, 10-20 mm, or 10-50 mm in length, though other dimensions may be used and each tool may not be the same size.

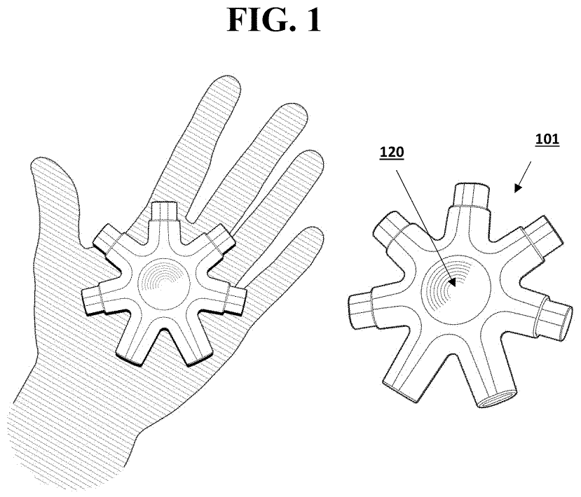

Once a male tool has been used it can be snapped back into the main body, for example as shown and described with respect to FIGS. 1-3. Alternatively, in a second mode of use, each male tool can be reversed and snapped into position. The tool heads can be exposed radially around the main body giving the user the ability to rotate the product, select a tool and proceed to clean the port, plug or other region of the device. Using a tool in its open configuration attached to the main body may make the tool easier for users with larger hands to hold and manipulate. These two modes of usability are made possible by the reversible tool and accommodating geometry inside the main body.

A multi-tool as disclosed herein may allow all the individual tools to be easily stored and protected as a combined device but accessed and used individually as required. The multi-tool includes a main body, with the individual tool tips attached to, or stored within, radial ‘spokes’ equally spaced around the central core. An example of such an arrangement is shown in FIG. 1

In an embodiment, the male tools, intended for use cleaning the device itself, may be detachable from the main multi-tool body with the individual tools housed in the multi-tool body when not in use. When removed, an individual tool can be held and used alone, or it can be reversed and inserted into the multi-tool wherein the multi-tool body acts as a convenient handle for easier grasping and manoeuvrability while the individual tool is in use. This also may allow the individual tool tips to be much smaller than would be the case without the overall multi-tool as a handle, keeping the overall multi-tool desirably compact.

Alternatively or in addition, a multi-tool as disclosed herein also may contain female tools that allow the cleaning of the typically male tips of cables and accessories that connect to the device for battery charging or data transfer. In such arrangements, the cable or accessory connector is inserted and removed into the female port, repeatedly if required, to wipe the connector's surface clean.

Alternatively or in addition, another female port may include an abrasive surface with a sprung or elastomer/rubber material ensuring the abrasive surface pushes against the connector, removing oxide damage from the connector of the cable or accessory, if required.

Embodiments disclosed herein may allow loose debris, such as hair, lint, tissue and other fine contaminants, to be easily removed from the electronic connection ports of the device, with no chance of damage to the port. They also may allow oil or liquid based contaminants to be wiped from the connection ports of the device using an tool incorporating an absorbent material soaked in an appropriate cleaning fluid such as isopropyl alcohol, specialized electrical contact cleaner or other cleaning fluid, allow easy cleaning of the small speakers, microphones, switches, buttons, cameras and other sensors requiring openings or protrusions in the mobile device's case, allow cleaning of both loose and ingrained or liquid contaminants from the sockets or connections of cables and accessories used with the device and the like.

Embodiments disclosed herein also may allow for the repair of arcing damage, typically causing black scorch marks of oxide on the electrical contacts, through fine abrasives that can remove the oxide layer built up on the electrical contacts, for both the female port on the device and the male connector on the cables and accessories.

Embodiments disclosed herein may combine one or more tool tips/heads targeting each of the above objects into a single overarching multi-tool that conveniently stores all the individual tool-tips, reduces the overall size of each tool by allowing the multi-tool body to be used as a handle during use, and protects the delicate tool-tips when they're not in use.

Embodiments disclosed herein may include a main tool body, with a plurality of individual tools permanently built into the main tool body, or snap fitting into the main tool body during storage or optionally during use. Preferred embodiments of the main tool body and individual tools are described below.

FIG. 1 shows an example of a main tool body 101 according to an embodiment disclosed herein. The main tool body 101 may include a central hub with a plurality of radial spokes housing either female tools or sockets for male tools, examples of which are described in further detail below, and specific examples of which are disclosed herein. A main tool body as shown in FIGS. 1-3 may be described as having a star or spoked shape, and the tool connection points to which the individual tools may connect may be described as being arranged radially around the outer edge of the main tool body. Although example embodiments illustrated herein show seven tools (5 male and 2 female in an embodiment) it will be understood that various embodiments may include fewer or more tools, such as 3, 4, 5, 6, 7, 8, or 9 tools, in any combination of male and female tools. In most embodiments at least one male and female tool may be included, so that both the female and male sides of the electrical connections maintained with the tool can be cleaned. The main body is configured to hold the male and female tools in respective portions of the body, such that they can be detached, reversed, and reconnected to the main body (typically for male tools), or held fixed in place (typically for female tools). The main body may be shaped so as to lie flat on a table or bench surface. It also may include a smooth and/or flat surface 120 which may be used as a grip surface during use, as well as providing a convenient location for logos, graphic instructions, notices, or the like. A user also may be able to easily rotate the tool body 101 with a single hand, for example by grasping the central portion of the tool body 120 between thumb and forefinger and rotating the tool body with other fingers.

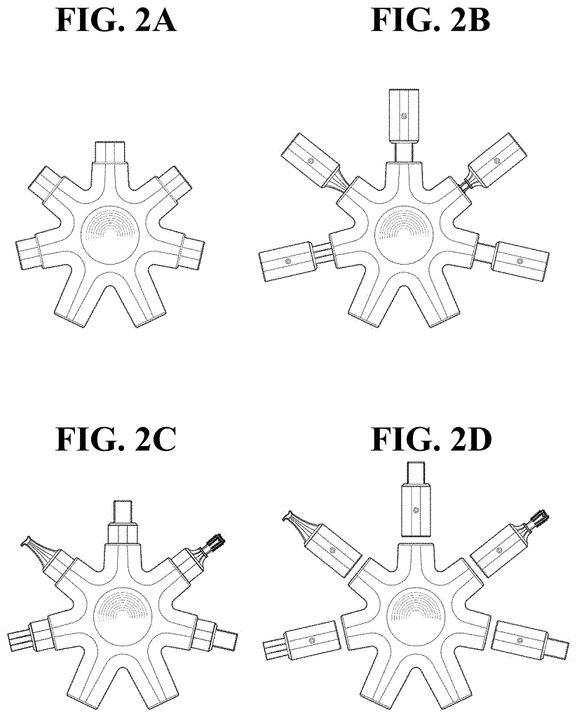

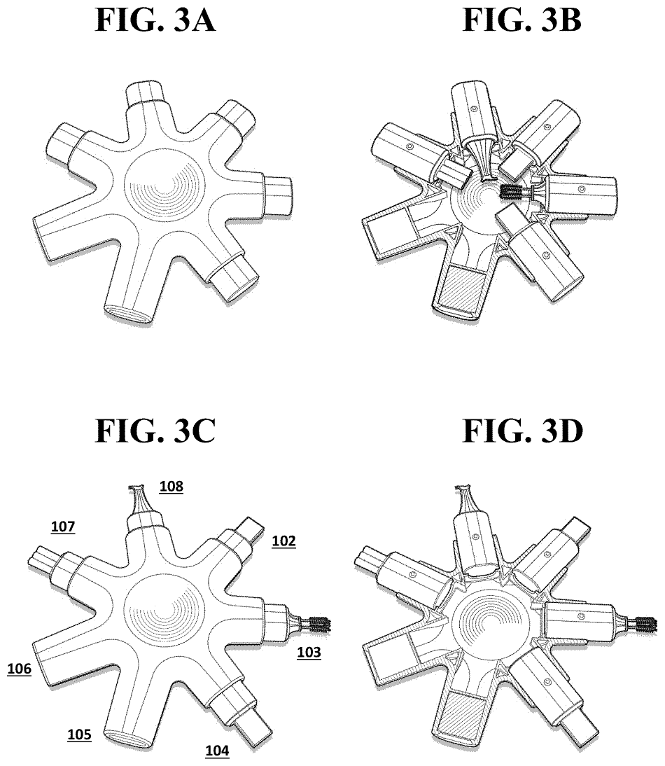

FIGS. 2A-2D and 3A-3D show examples of a multi-tool as disclosed herein. In FIG. 2A, the tool is in a “closed” state, in which each of the individual tools is secured inside the tool body. In FIG. 2B, the male tools are shown partially removed from the tool body. FIG. 2C shows the male tools reversed and secured in the tool body, such as for when the tools are in use. During use of the multi-tool, one or more of the single tools may be positioned as shown in FIG. 2C. In many cases, only a single tool will be arranged as shown in FIG. 2C during operation by a user. FIG. 2D shows the male tools completely removed from the multi-tool body.

FIGS. 3A-3D show additional examples of a multi-tool as disclosed herein with individual tools shown. FIG. 3A is a perspective view of the multi-tool with the male tools stored in the tool body. FIG. 3B shows the same perspective view as 3A, but with the tool body cut away to show the male tools positioned within the tool body. Similarly, FIGS. 3C and 3D show a view of the multi-tool with the male tools reversed and secured in the tool body, in perspective and cut-away views, respectively. Seven example tools are shown, though it will be understood that a multi-tool as disclosed herein may include more or fewer individual tools, which may be stored in and/or connect to the tool body as described with respect to the examples provided. In FIG. 3, the example tools shown include a port abrasive 102, a port brush 103, a port cleaning tool suitable for use with cleaning solutions (“port solution tool”) 104, a plug abrasive tool 105, a plug tool suitable for use with cleaning solutions (“plug solution tool”) 106, a device brush 107, and a port pick 108. In an embodiment, the sub-tools may be arranged for storage in linearly arranged docks along the handle of the main body and inserted in a single dock at the end of the main body for use.

In an embodiment, the sub-tools are arranged in a cylindrical pattern around the top of the handle of the main body and inserted in a single dock at the other end of the main body for use.

In an embodiment, the male tools attach to the main body through a snap or click fit action but in alternative embodiments could be screwed or friction fitted to the body. The male tools may be stored in the closed state, thereby protecting the delicate individual tool tips and providing a neat presentable aesthetic when all tools are closed.

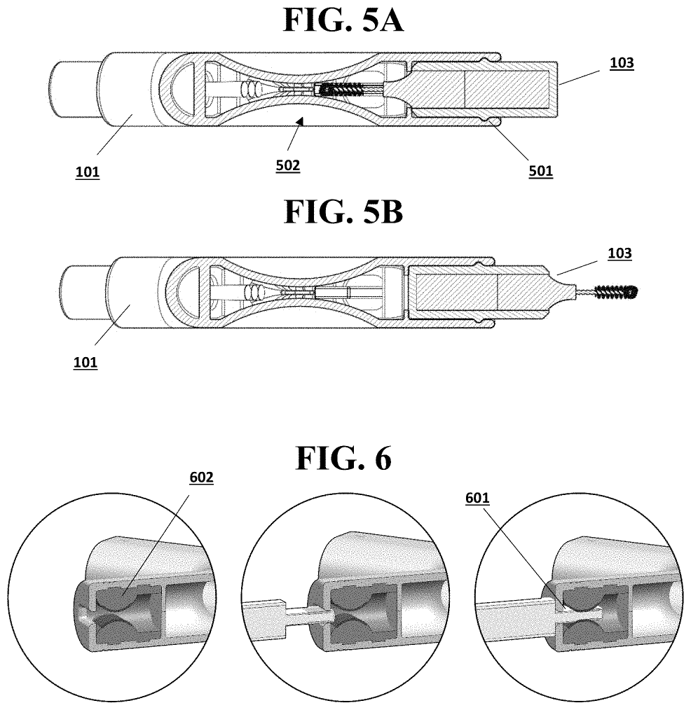

Individual male tools may be removable by a user, for example with one hand grasping the individual tool and the other holding the tool body. Once removed, each individual male tool may be used independently (as shown, for example, in FIG. 5B), or reversed and fitted back into the main body, with the main body then held as the handle for the tool (as in FIG. 5A). Thus, this arrangement provides two modes of use for each male tool, depending on the individual user's preference and hand/finger size.

In an embodiment, female tools may be embedded in removable sub-tools, used independently of the main body or reversed into the main body. This arrangement allows the main body to act as a cap for the female tool, providing a seal over the tool that allows absorbent material in such a tool to be pre-soaked in cleaning fluid and remain moist and thus effective at cleaning for an extended period of time (assuming it is returned to the closed position, recapped, by the user, when not in use).

In an embodiment, the female tools may be equipped with separate protective caps. As above, this may only be required if they contain absorbent material pre-soaked with a liquid cleaner that would evaporate if a cap was not applied.

In an alternative embodiment, the male tools are permanently attached to the main tool body and each male tool is covered by a simple cap that is removed during use.

In an embodiment, a combination of the above approaches may be used for different male and female tools in the same main tool body.

Although examples of illustrative tools are described below, it should be noted that any combination of these or other tools may be included in one or more embodiments.

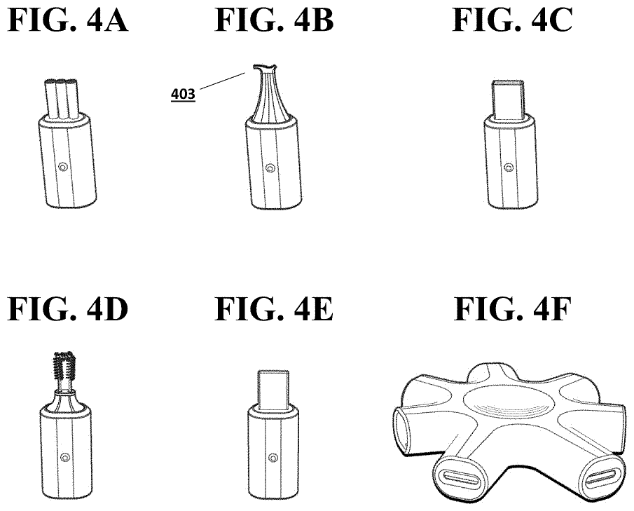

FIGS. 4A-4F show detail views of examples of individual tools such as tools 101-107 shown in FIG. 3C, which may be included in a multi-tool as disclosed herein.

FIG. 4A shows an example of a device brush 107. This tool may include a simple synthetic bristle brush, similar to a toothbrush, with bristle length, diameter, cluster size, and colour chosen to best clean the various other fine incisions on the device that may collect debris. This tool may be used, for example, to clean switches, buttons, microphones, speakers or speaker holes, headphone jacks or similar connection ports, and other components of a device which are prone to collecting contaminants. Various sizes of brush bristles may be used, for example, 0.1, 0.2, or 0.3 mm in diameter and 8, 10, or 12 mm in length, extending 7, 7.5, or 8 mm out from the tool body.

FIG. 4B shows an example of a port pick 108. This tool may be made, for example, from any type of rigid plastic or metal and is shaped to allow large debris, e.g. lint or tissue clumps, to be scraped out of the female port or ports on the device. It may be fitted to suit a specific port, such that it can easily reach into the specific internal cavity of the port and remove lodged or congealed debris such as lint lodged at the back of the port, without damaging the delicate electrical contacts and other components of the port. It may be particularly suited and useful for removing debris trapped above and/or below a retention spring of the port. The end of the pick may include one or more protrusions 403 that extend outward from a central portion to allow for reaching the edges and corners of a port. The pick may include multiple protrusions of different shapes and sizes, or it may be symmetrical along a central axis such that each protrusion is the same size and shape. In some embodiments, one or more protrusions may be sized and shaped to displace debris from a standard port size. In some embodiments, different sizes of protrusions may be used, such as to remove debris from above or below a retaining spring, the rear wall of the port, or the edges of a rectangular port. The pick may be tapered in shape such that the end of the pick is narrower than the base near the handle portion that connects to the main tool body. The pick may be, for example, about 0.3-0.7 mm, in thickness.

FIG. 4C shows an example of a male port abrasive 102. This component may include an abrasive surface positioned to contact that electrical contacts in the device when inserted/removed into a female port on the device. This action may engage abrasively into the surface of the electrical contact pins in the device, removing potential oxide/arcing damage coating the pins which may be causing increased resistance or unreliable electrical contacts between the device and charging cables or accessories. The abrasive surface may be paper based (sand paper), metal based (metal files including but not limited to pumice, diamond or sapphire abrasive particles), or elastomer, rubber or plastic with an abrasive particulate included in their material.

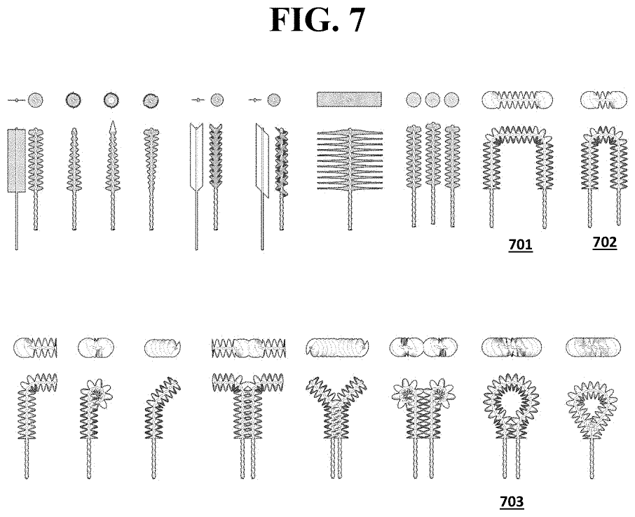

FIG. 4D shows an example of a port brush 103 suitable for cleaning inside a port of a portable electronic device, such as the charging port of a smart phone, tablet, or the like. This component may include a fine twisted wire brush that may be used to brush any loose debris (lint, tissue, hair, dust and any other contaminants) from female ports on the device. Note that the weight/thickness of the wire, bristles and overall brush diameter may be chosen to suit a particular device port or ports exactly, or dimensions may be used that are likely to work generally with a large number of portable devices. As shown in FIG. 7, a port brush as disclosed herein may be bent into a shape suited for cleaning of the exact port of a specific device. Brush shapes may be single, double or triple stemmed, including loop and twin single/triple brush layouts, with various shapes to suit a specific device and its port cavity shape. It may be preferred for the port brush to be entirely curved, such as the curved shapes 701, 702, 703, and thereby be devoid of any sharp corners or edges, which may prevent unintentional damage to a port. A port brush tool as disclosed herein may be particularly useful, for example, in removing small debris from corners and crevices of a port. In some embodiments, the tool body may taper to provide greater visibility of the brush during use. In some embodiments, the body of the tool may be longer on the brush portion, thereby providing more surface area for the user to manipulate the tool into its reversed snap-fit position (i.e., placed into the tool body for use as opposed to storage).

FIG. 4E shows an example of a port “nib” or “solution tool” 104. This component may include a solid but absorbent material, including compressed paper or cellulose (synthetic) nib materials, such as those typically used in pens and markers, and a handle. Alternatively, the nib may be made of a plastic blade covered with rubber, thermoplastic resin, or the like, or include a rubberized surface. The blade may include a grooved or otherwise textured surface to aid in transferring a cleaning solution to the port. The absorbent nib of the tool may be moistened by the user with an appropriate cleaning liquid such as isopropyl alcohol, methylated spirits, specialized electrical contact cleaners, or the like, or the nib may be pre-moistened. In some embodiments, it may be preferred to use more viscous and/or sticky cleaning fluids to achieve better adhesion to the tool between application of the cleaning solution and use of the tool to clean the port. The nib tool may be inserted and removed from the port, potentially many times, rubbing the internal side and back walls of the port and cleaning them where engrained, stained or other liquid/attached debris is within the port.

FIG. 4F shows examples of female connector and nib tools 105, 106. The female nib tool may provide a similar or identical absorbent material as described with respect to FIG. 4E, moistened with an appropriate cleaning fluid. Male connectors on various charge/data cables or other accessories can be cleaned with the female tool, by inserting and removing the connector (potentially multiple times if required) to wipe the connector surfaces. The female connector tool may incorporate an abrasive surface that rubs on the electronic contacts of the male connector or accessory, remove a tiny amount of surface from the connectors and in so doing removing any visible oxide/arcing damage, similar to the corresponding male tool as previously disclosed. As another example, a female connector nib and abrasive tool may include materials that are based on a foam, such as where the nib is an absorbent foam material. Alternatively or in addition, the abrasive surface may be backed with foam about 2-3 mm thick to provide a “spring: effect and pressure on the connector, thereby avoiding the need for a mechanical spring or equivalent.

Generally, abrasive tools as disclosed herein may apply pressure to the accessory when inserted, through any or a combination of approaches, a plastic or metal ‘sprung’ surface to which the abrasive is attached, or an elastomer or rubber that either contains the abrasive particulate, or to which sand paper is attached. In this approach the spring action provides pressure of the abrasive surface to the connector's surface. In some embodiments, the pressure is applied simply by tight or negative fit, and sufficient flex in the body or surface of the abrasive component.

In some embodiments, one or more tools may include features of multiple tools as disclosed herein. For example, a tool may include both an abrasive component as well as a pick or brush portion. As another example, the body of a pick may include an absorbent material that may be used with a cleaning solution as well as the protrusions described with respect to the pick tool. Furthermore, additional tools may be used that may be different from those disclosed herein, or may include some features of other tools disclosed herein. For example, a tool may include a plastic blade that is shaped to fit a particular port, such as a Lightning™ port or similar. The plastic blade may be coated with rubber or a similar material, and a cleaning solution may be applied to the blade during use. Such a tool may serve the same purposes as an abrasive port tool as previously disclosed, by rubbing the electrical contacts of a port with the cleaning solution to clean them.

FIGS. 5A and 5B show an example of a male tool 103 disposed in the tool body 101 for storage and rotated for use and re-inserted in the tool body, respectively. Each individual male tool may have ridges, protrusions, or other features 501 that allow the tool to be seated in the tool body in either orientation. For example, as shown in FIGS. 5A and 5B, the tool may include a ridge, annular bumps, or other protrusion that interlocks with a groove or other feature in the tool body to allow the tool to be placed in either orientation. In the orientation shown in FIG. 5B, the tool body 101 may be used as a handle for the tool 103, thereby allowing for easier manipulation of the tool. The tool 103 may “snap-fit” into the tool body 101 in one or both orientations, which may produce an audible sound to inform a user that the tool is properly or completely seated in the tool body. As a specific example, a snap-fit may be used to “lock” the male tools in place. In this configuration there may be, for example, two annular bumps (hemispheres) or other protrusions as previously disclosed, which are located on the outside of the male tool body on the handle portion and two mating annular dimples on the inside of the main body's stem. The male tool remains rigid and the hollow circular stem sections of the main body may deform when the male tool is inserted and physically interferes. The main body's circular stem sections will experience hoops stress loading every time the tool is pushed in and pulled out.

It may be preferred for a snap fit to be sufficiently tight that the pull out force is low enough for the user to easily pull out the tool, yet high enough to lock the tool in place and oppose any forces encountered during cleaning. Alternatively or in addition, one or more cantilevered springs or equivalent features 502 may be disposed within the tool body to provide appropriate reactive force when the tool is inserted into the tool body. With the individual male tools “closed” into the main body, the user has a limited section of the male tool handle to hold and friction only to grip that, so it may be desirable that the snap fit is not too tight.

Furthermore, depending upon the particular fabrication techniques used, the two halves of the main body may be welded at their parting surfaces and this joint may experience normal tensile stresses from inserting and removing the tools. Accordingly it may be preferred for the weld to be sufficiently strong to withstand this tensile force during the cycles of loading. For example, approximately 0.5-0.25 mm of annular interference, equivalent to 1.0-0.5 mm diametric interference, may be used.

Although FIGS. 5A and 5B are shown using a brush tool 103, it will be understood that similar or identical configurations may be used with other individual male tools, include without limitation some or all of the tools disclosed herein.

In an embodiment, the female tools used to clean the cable plugs may be fixed into the stems of the main body, for example as shown in FIG. 4F. This arrangement follows, for example, the lightning ports found on Apple devices and similar ports found on other mobile electronic devices, and thereby may appear familiar and intuitive to the user. The female tools may not include any retention cantilever springs like a conventional connection port. This means, for this design configuration, there may be no clicking feedback once a lighting plug is pushed in and pulled out from the female tool. In an embodiment, a female tool may include a compliant material arranged around the opening for the plug that deforms to apply a compressive force onto the plug, as shown in FIG. 6. As the user pushes in and pulls out the male connection plug 601, the compliant material 602 may exert pressure against the plug 601, which provides a rubbing and wiping action thereby cleaning the top and bottom faces of the plug 601. As previously disclosed, the compliant material may include a foam-backed abrasive or similar configuration. In an example embodiment, the nominal size of a female plug chassis may be 1.5×6.6×7.0 mm, though other sizes may be used. Alternative configurations can include features that produce the “click” feedback when plugs are inserted and removed.

As previously disclosed, some tools may include abrasive components or portions. For example, a plug abrasive tool as disclosed herein may use an abrasive medium to remove scorch marks and corrosion from the electrical pins. The abrasive medium may include, for example, sandpaper or emery cloth. ANSI grit sizes of, for example, 800-1200 ANSI may be used. During use, using light finger pressure, such abrasive papers may use 4 and 3 micron diameter aluminium oxide particles.

In some embodiments, a port solution tool and/or a plug solution tool as disclosed herein may use a soft compliant material that will hold a cleaning fluid via wicking action and wipe over the plug and inside the port. For example, polyester fibre nibs as used in pens and markers may be used to provide suitable texture, form and functionality we require. The cleaning action of a polyester nib soaked in a cleaning fluid may be effective in removing dirt and skin oils from a connection plug and port. Solutions such as isopropyl alcohol, specialized electrical contact cleaners, or the like may be used for cleaning plugs and ports. Such cleaning fluids may be non-polar, highly evaporative in ambient conditions, have anti-bacterial characteristics, may be soluble in dirt/oil and may be designed or otherwise suited for used in cleaning electrical components and contacts. An applicator, such as a pharmaceutical-grade eye dropper or similar fluid applicator, may be used administer a few millilitres of cleaning fluid at once. Such a volume may be preferred for applying to the tip and apertures of the product's soft cleaning tools. A 50 ml capacity is suitable for most embodiments.

Other components may be included in a package with a multi-tool device as disclosed herein. For example, a microfiber cloth may be provided to allow users to clean the device screen and body. A cleaning fluid may be dropped into the cloth then wiped over the surface of the device. As another example, a paper pulp product holder may be used to integrate the product, the cleaning fluid dropper and the microfiber cloth for logistical storage and transport.

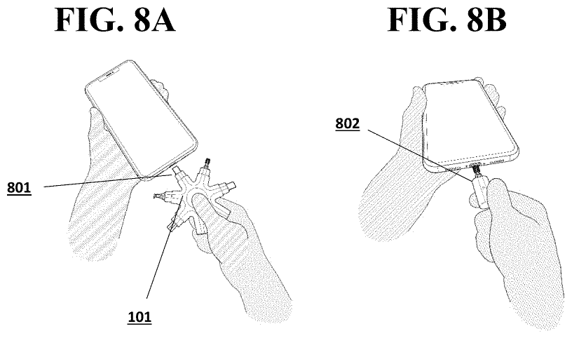

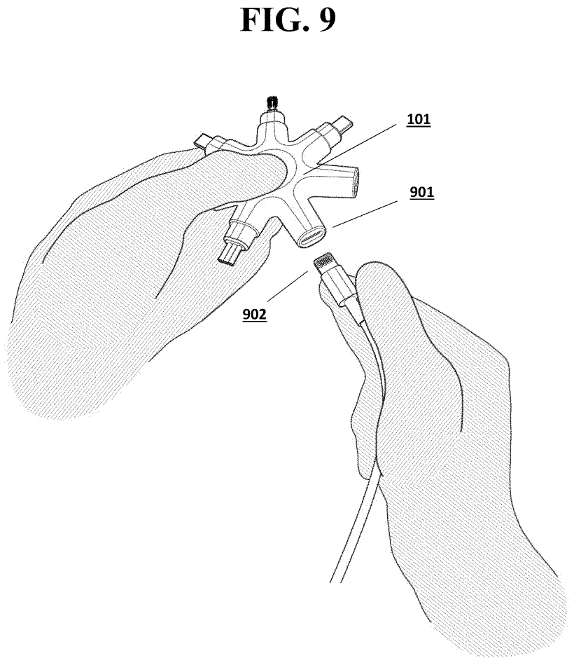

As previously disclosed, in some embodiments, each tool may be removed from the main body, reversed or otherwise changed in orientation, and reconnected to the main body for use. Alternatively or in addition, each tool may be used independently of the main body. FIGS. 8A-8B show examples of such uses. FIG. 8A shows an example of a male tool 801 that has been connected to the main body 101 for use, where the main body 101 is used as a handle for the tool 801. FIG. 8B shows an example of a tool 802 that has been removed from the main tool body and used independently of the body. In general, any tool disclosed herein may be used in either fashion. In some embodiments, female tools may be integral with the main tool body such that they cannot be removed and used independently of the main tool body, as previously disclosed. FIG. 9 shows an example of a female tool 901 being used to clean a connector 902, such as a connector on the end of a charging or data cable used with an electronic device. In this example, the female tool 901 is integral with the main tool body 101 and cannot be removed and used independently.

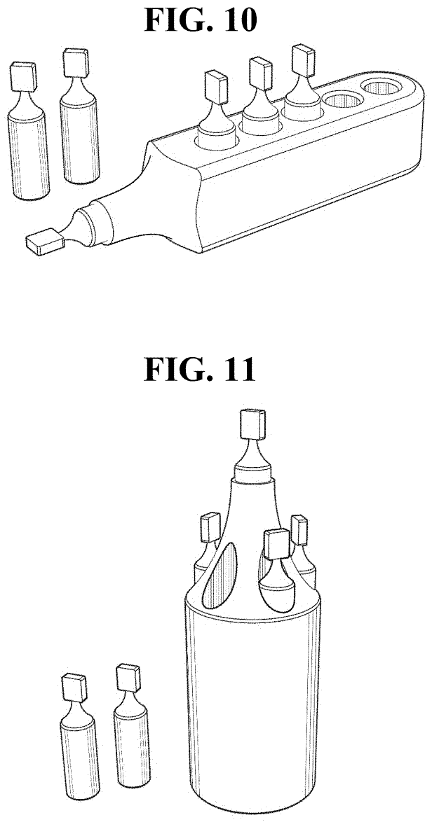

Although the examples previously used herein are described with respect to a generally circular main tool body with individual tools arranged radially around a central portion of the body, other configurations may be used. For example, FIG. 10 shows a configuration in which tools may be stored linearly along the handle of the main body and a single tool may be inserted into the end of the main body for use. As shown, the main tool body of the multi-tool device may be generally linear and may include a handle portion in which the tools are stored and a tool connection end to which individual tools may be connected during use. As another example, FIG. 11 shows an embodiment in which tools may be arranged cylindrically around the handle of the main body and a single tool may be inserted into the end of the main body for use.

The foregoing description, for purpose of explanation, has been described with reference to specific embodiments and examples. However, the illustrative discussions above are not intended to be exhaustive or to limit embodiments of the disclosed subject matter to the precise forms disclosed. Many modifications and variations are possible in view of the above teachings. The illustrative embodiments were chosen and described in order to explain the principles and operation of the disclosed subject matter and their practical applications, to thereby enable others skilled in the art to utilize those embodiments as well as various embodiments with various modifications as may be suited to the particular use contemplated.

1. A device for cleaning an electrical device, comprising:
a plurality of tools, each tool comprising a handle portion and a cleaning portion, each cleaning portion being different from the cleaning portion of each other tool; and
a main tool body comprising a plurality of tool connection points;
wherein the handle portion of each tool is configured to removably connect to the main tool body via at least one of the tool connection points; and
wherein each tool of the plurality of tools is connectable to the main tool body such that the cleaning portion is disposed within the main tool body, and each tool of the plurality of tools is also connectable to the main tool body such that the cleaning portion is disposed outside the main tool body.

2. The device of claim 1, wherein the main tool body further comprises one or more female cleaning tools integral with the main tool body, and each female tool comprises a cleaning portion disposed within the main tool body.

3. The device of claim 2, wherein the one or more female cleaning tools comprises an abrasive surface.

4. The device of claim 2, wherein at least one tool of the one or more female cleaning tools comprises a compliant material disposed around an opening of the tool that deforms to apply a compressive force onto a plug inserted into the tool.

5. The device of claim 2, wherein the device comprises two female tools and the plurality of tools comprises four male tools.

6. The device of claim 1, wherein the main tool body has a spoked shape and the tool connection points are arranged radially around an outer edge of the main tool body.

7. The device of claim 6, wherein the tool connection points are disposed uniformly around the outer edge of the main tool body.

8. The device of claim 1, wherein each of the plurality of tools is removably connectable to each of the tool connection points.

9. The device of claim 1, wherein each of the tool connection points comprises an opening in the main tool body.

10. The device of claim 9, wherein the handle portion of each of the plurality of tools comprises a protrusion that snap-fits to a corresponding recess in each of the tool connection points.

11. The device of claim 9, wherein the handle portion of each of the plurality of tools comprises a recess that snap-fits to a corresponding protrusion in each of the tool connection points.

12. The device of claim 1, wherein the plurality of tools comprises a curved brush tool.

13. The device of claim 12, wherein the tool portion of the curved brush tool comprises a brush that does not have any points or sharp edges.

14. The device of claim 1, wherein the plurality of tools comprises a port solution tool, which comprises an absorbent material.

15. The device of claim 1, wherein the plurality of tools comprises a rigid blade coated with a compliant material.

16. The device of claim 15, wherein the compliant material is capable of transferring a cleaning solution from the tool to contacts within a port of an electronic device.

17. The device of claim 15 wherein, when the rigid blade is inserted into a port of an electronic device, the compliant material exerts a force against inside surfaces of the port.

18. A system comprising:
a first device, the first device comprising:
a plurality of tools, each tool comprising a handle portion and a cleaning portion, each cleaning portion being different from the cleaning portion of each other tool; and
a main tool body comprising a plurality of tool connection points;
wherein the handle portion of each tool is configured to removably connect to the main tool body via at least one of the tool connection points; and
wherein each tool of the plurality of tools is connectable to the main tool body such that the cleaning portion is disposed within the main tool body, and each tool of the plurality of tools is also connectable to the main tool body such that the cleaning portion is disposed outside the main tool body;
a cleaning fluid dispenser configured to hold an electrical contact cleaning solution; and
a package comprising storage portions for the first device and the cleaning fluid dispenser.

19. The system of claim 18, further comprising a cleaning cloth.
